(19) United States
(12) Patent Application Publication
(10) Pub. No.: US 2005/0093437 A1
(43) Pub. Date: May 5, 2005

(54) OLED structures with strain relief, antireflection and barrier layers

(76) Inventor: Michael X. Ouyang, Painted Post, NY (US)

Correspondence Address: William S. Francos, Esq.;VOLENTINE FRANCOS, P.L.L.S., 2 Meridian Boulevard, Wyomissing, PA, 19610, US

(21) Appl. No.: 10/698,723

(22) Filed: Oct. 31, 2003

(51) Int. Cl. H05B 33/00

(52) U.S. Cl. 313/506; 313/511

(57) ABSTRACT

An OLED structure includes a substantially flexible substrate, at least one barrier layer disposed between the substrate and the OLED structure, and at least one antireflection layer disposed between the OLED structure and a display surface. The barrier layer may include up to ten stacks, where each stack includes a dielectric layer and a light absorbing layer. Additionally another flexible substrate may be disposed over the barrier layer.

### BACKGROUND

Organic light emitting devices/diodes (OLEDS) are light emitting devices that are often made from electroluminescent polymers and small-molecule structures. These devices have received a great deal of attention as alternatives to conventional light sources in displays and other applications. In particular, OLED-based displays may be an alternative to liquid crystal (LC) displays, because the LC materials and structures tend to be more complicated in form and more limited in application.

Beneficially, OLED-based displays do not require a light source (backlight) as needed in LC displays. As such, OLEDs are a self-contained light source, and thus are much more compact than their LC counterparts. Furthermore, OLED-based displays remain visible under a wider range of conditions. Moreover, unlike LC displays which rely on a fixed cell gap, OLED-based displays can be flexible.

While OLEDs provide a light source for displays and other applications with at least the benefits referenced above, there are certain considerations and limitations that have thus far reduced their ubiquitous implementation. One drawback of OLED materials and devices is their susceptibility to environmental contamination. In particular, exposure of an OLED display to water vapor or oxygen can be deleterious to the organic material and the structural components of the OLED. As to the former, the exposure to water vapor and oxygen can reduce the light emitting capability of the organic electroluminescent material itself. As to the latter, for example, exposure of the reactive metal cathode commonly used in OLED displays to these contaminants can over time result in ‘dark-spot’ areas and reduce the useful life of the OLED device. Accordingly, it is beneficial to protect OLED displays and their constituent components and materials from exposure to environmental contaminants such as water vapor and oxygen.

In order to minimize environmental contamination, known OLED displays are commonly fabricated on thick, rigid glass substrates, with a glass or metal cover sealed at the edges. However it is often desirable to provide the OLEDs on a lightweight flexible substrate. For example, it would be beneficial to use thin plastic (e.g. polymer) substrates in this manner. Unfortunately plastic substrates, such as polycarbonate, are unacceptably susceptible to water vapor and oxygen permeation. Known moisture and oxygen barrier layers are often brittle, and thus not useful in flexible substrate applications. Finally, rather thick layers of polymer dielectric materials have been considered as barrier layers. However, known thick-layer materials used in this manner may create curvature of the desirably flat screen. Accordingly, these too are thus not suitable for use in flexible substrate OLED displays.

In addition to the shortcomings of known structures outlined above, issues of the visibility of the display in certain lighting-conditions have rendered known OLED structures unsuitable for many applications. For example, in sunlight and other situations where the ambient light is rather high, the display can be rendered unreadable by the ambient light. As such, this situation, commonly referred to as ‘wash-out’, has limited the use of OLED's in certain display applications, such as handheld devices.

What is needed therefore is a display structure that overcomes at least the shortcomings described above.

### SUMMARY

In accordance with an example embodiment, an OLED structure includes a substantially flexible substrate, at least one barrier layer disposed between the substrate and the OLED structure, and at least one antireflection layer disposed between the OLED structure and a display surface.

### BRIEF DESCRIPTIONS OF THE DRAWINGS

The exemplary embodiments are best understood from the following detailed description when read with the accompanying drawing figures. It is emphasized that the various features are not necessarily drawn to scale. The dimensions may be arbitrarily increased or decreased for clarity of discussion.

FIG. 1 is a partially exploded view an OLED structure in accordance with an example embodiment.

FIG. 2a is a cross-sectional view of a barrier/antireflection coating/rear reflection structure in accordance with an example embodiment.

FIG. 2b is a cross-sectional view of a barrier/antireflection coating/rear reflection structure in accordance with an example embodiment.

FIG. 3 is a cross-sectional view of an antireflection coating structure at the front (viewing) side of the substrate in accordance with an example embodiment.

FIG. 4 is a graphical representation of the reflectance versus wavelength of a three-layer antireflection stack in accordance with an example embodiment.

FIG. 5 is a graphical representation of the reflectance versus wavelength of a three-layer antireflection stack in accordance with an example embodiment.

### DETAILED DESCRIPTION

In the following detailed description, for purposes of explanation and not limitation, example embodiments disclosing specific details are set forth in order to provide a thorough understanding of the present invention. However, it will be apparent to one having ordinary skill in the art having had the benefit of the present disclosure that the present invention may be practiced in other embodiments that depart from the specific details disclosed herein. Moreover, descriptions of well-known devices, methods and materials may be omitted so as to not obscure the description of the present invention.

In the example embodiments described herein, structures for OLED's are set forth in significant detail. It is noted, however, that this is merely an illustrative implementation. To wit, the invention is applicable to other technologies that are susceptible to similar problems as discussed above. For example, embodiments in photonics and displays including other types of light sources are clearly within the purview of the present invention. These include but are not limited to integrated circuits and semiconductor structures. Finally, it is noted that the example embodiments may be used in a variety of applications. These applications include but are not limited to display devices such as handheld devices and computer displays.

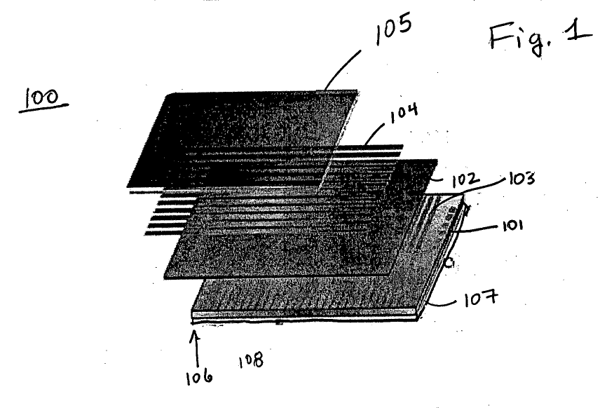

FIG. 1 shows an OLED structure 100 in accordance with an example embodiment shown in a partially exploded view. The OLED structure 100 includes a substrate 101 that is beneficially transparent to visible light. Illustratively, the material chosen for the substrate provides the desired strength and scratch resistance at the viewing surface 106. The substrate 101 is illustratively a polymer material, such as plastic, or a suitable glass layer, or a combination of glass, polymers and other materials. In example embodiments in which the substrate 201 is a polymer, the polymer may be polycarbonate, polyolefin, polyether sulfone (PES), polyethylene terephthalate (PET), polyethylene naphthalate (PEN), polyimide, and others. In an example embodiment such polymer layers have a thickness on the order of approximately 50 μm to approximately 10⁵ μm. Additionally, the substrate may include a nanocomposite film, which provides a barrier to water vapor and oxygen that is disposed over a suitable material that provides flexibility. Furthermore, layers of these materials may be used in various and sundry combinations. Regardless of its composition, substrate 101 beneficially is flexible so the OLED structure can be flexible.

Beneficially, the substrate 101 provides a base upon which the OLED devices may be disposed, and is flexible. The substrate itself may also be barrier to contaminants such as water vapor, or oxygen, or both, and prevents contaminants from reaching a layer 102 that includes the OLEDs. Alternatively, another layer(s) to prevent contamination may be disposed over the substrate 101. In the example embodiment of FIG. 1, an antireflection (AR) layer 107 acts as a barrier layer to contaminants. As will become clearer as the present description continues, a layer 105 is disposed over layer 102 and protects layer 102 from contaminants. Quantitatively, it is useful for the barrier layers to provide a barrier to water vapor so that its permeation through the barrier is less than approximately 10⁻⁶ g/m²/day and a barrier to oxygen so that the permeation of oxygen through the barrier is less than approximately 10⁻⁵ cm³/m²/day.

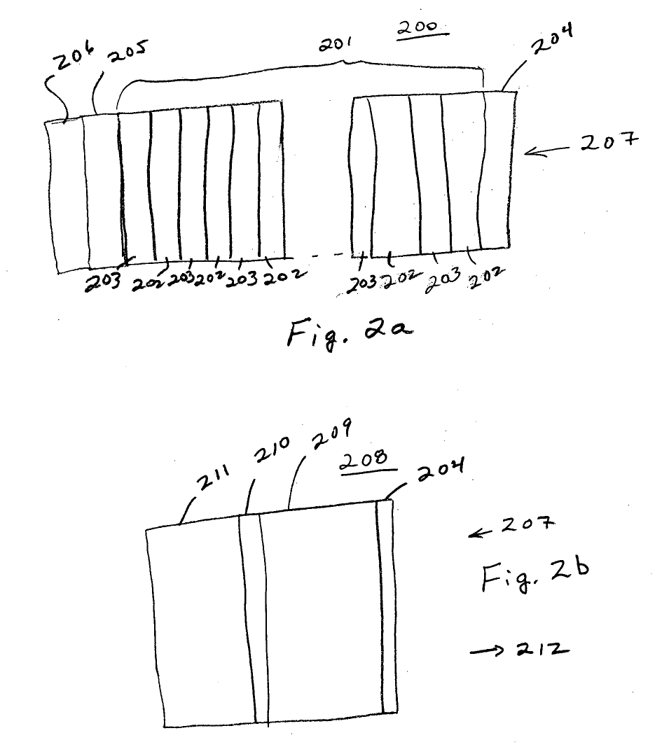

Layer 102 is illustratively a multilayer structure that includes the OLEDs of the example embodiment. Illustratively, layer 102 is a three-layer stack comprised of an electron transport layer (ETL)/a light emission layer (EL)/a hole transport layer. These layers, which are not shown in FIG. 2, are deposited by thermal evaporation or spin coating, and form the OLED layer of the OLED structure 100. Layer 102 may be of the type described in “Prospects and applications for organic light-emitting devices” to Burrows, et al. Current Opinion in Solid State and Materials Science 1997. The disclosure of this article is specifically incorporated herein by reference. Anode lines 103 and cathode lines 104 are disposed on either side of the layer 102 to provide the necessary voltage to the OLEDs to effect illumination. These lines are generally metal, and are deposited by standard technique.

The cathode lines 104 are illustratively comprised of a low work function metal for electron injection. For example, the cathode lines may be Ca, Li, Mg or an alloy such as Mg/Ag, Al/Li or a multilayer material such as LiF/Al, Li₂O/Al, CaF/Al structures. The anode lines 103 must be substantially transparent to visible light. Indium tin oxide (ITO) with a surface modified to provide a high work function is used in this capacity in the example embodiment. To this end, ITO is a transparent conductive layer, which is coated on the substrate 101. ITO also injects holes to the EL layer via the HTL. This surface treatment can increase the work function, which results in a lower potential barrier to hole injection.

As can be readily appreciated, packaging is an important to the longevity of OLED-based devices, which is particularly the case for OLED-based devices on flexible substrates. In the exemplary embodiments described herein, layer 105 is comprised of a plurality of thin metal layers and transparent dielectric layers that are disposed in an alternating or layered structure. The metal layers each have a thickness in the range of approximately 1 nm to approximately 100 nm, and the transparent dielectric layers each have a thickness of approximately 10 nm to approximately 300 nm. In order to suitably create a black background by curbing reflections of environmental light and to provide a suitable contaminant barrier layer, one to ten stacks may be used to form layer 105, where as stack is one layer of dielectric and one layer of absorbing metal.

Beneficially, the stress type of thin metal layers of the stacks of exemplary embodiments is modified to be either tensile or compressive to compensate stress of dielectric layers (usually compressive) of the stacks. Therefore, compressive stressed film/tensile stress film will cancel the stress and the display will not ‘curl.’ Moreover, the thin metal films are ductile and the dielectric layers, which are acting as moisture barrier layers, are divided into several thin layers separated by thin metal layers. Advantageously, this structure is flexible and the moisture barrier layers will not break due to bending.

Another useful aspect of the structure of the layer 105 is its anti-reflection property and its function as the back layer for a display device in which the OLED structure 101 functions. To wit, the laminated structure can only be put at the back side of the display, as the barrier/AR layer at the viewing surface must be transparent to visible light. As described in further detail herein, the layer 105 may be a stack including a quarter-wavelength dielectric layer, a reflective layer and a light absorbing layer.

Finally, it is noted that a layer of hydrophobic material (not shown in FIG. 1, such as a suitable hydrophobic polymer, may be disposed over rear-most surface of the layer 105, and a backside substrate (not shown) is disposed over the layer 105 or over the hydrophobic layer. It is noted that unlike substrate 101, the back substrate need not be transparent, and thus may be chosen for its flexibility and its ability to prevent contamination, without regard to its transparency to visible light. Such material include but are not limited to polymers, metals, glass and other materials within the knowledge of one of ordinary skill in the art.

On the side of the substrate closest to the viewing side 106 an AR layer 107 is disposed. The AR layer 107 beneficially prohibits the reflection of light incident on the viewing surface 106 (e.g., ambient light that impedes the viewing of the output of a display that includes the OLED structure 100 by the wash-out effect). To wit, light incident on the viewing surface from direction having components oriented opposite to the emission direction 108 of the OLEDs, is substantially prevented from being reflected at the viewing surface 106. As described in further detail herein, the AR layer 107 may be a multilayer dielectric stack that provides a cancellation effect of the light incident on the viewing surface. This physical phenomenon is well-known, and requires the careful selection of the thicknesses, indices of refraction and number of layers of the dielectric stack.

In addition to its antireflective properties, the dielectric layers of the AR layer 107 provide a suitable barrier to prevent contaminants such as water vapor and oxygen from traversing the substrate 101 and reaching the layer 102 or other layers. As such, hermeticity at the viewing side 106 of the OLED structure is provided by the dielectric AR layer 107.

In example embodiments referenced above and described in detail herein, the AR layer 107 serves as an antireflection layer to ambient light incident on the viewing surface 106. This AR layer 107 also provides flexibility, a barrier against oxygen and water vapor, and resistance to scratching. Layer 105, which is on the side of layer 102 opposite the viewing surface 106, provides the barrier against contaminants, most notably water vapor and oxygen. Layer 105 also provides a black or dark background for the viewing side 106 by reducing reflection of ambient or environmental light. As will become clearer as the present description continues, layer 105 may include a light-absorbing layer, such as an antireflecting dielectric stack to provide this desired dark-background at the rear surface of the OLED structure 100. As can be appreciated, a black background is very important for a display to function in a bright ambient or background lighting. Glares and surface reflection may prevent you from viewing an image if viewing the display in bright background lighting such as sun-light. In the example embodiments, the dark or black background provides a sharp image with comparatively reduced glare.

FIG. 2a shows a coating structure 200 for a rear layer 105 of the OLED structure 100 in accordance with an example embodiment. The coating structure 200 is a multi-layer structure 201 disposed on the ‘back’ side of the OLED device (e.g., on the side of layer 102 that is opposite to the side closest to the viewing surface 106.) This multilayer structure 201 includes at least one stack comprised of a light absorbing layer 202, and a transparent layer 203. The light absorbing layer is illustratively a metal, and the transparent layer 202 is a dielectric material. In the example embodiment there may be one stack and as many as ten stacks. It is further noted that a layer of dielectric 204 must be disposed between the first layer of metal in the multilayer structure 201 and the cathode lines of the OLED structure. Finally, a hydrophobic layer 205 may be disposed between the multi-layer structure and a rear or backside substrate 206. The hydrophobic layer 205 has a thickness in the range of approximately 10 nm to approximately 300 μm.

It is noted that oxygen is less damaging to the OLED devices than water vapor. However, an oxygen barrier is much more difficult to realize. Material structures with a short atomic separation/distance and a lower propensity for the migration of oxygen atoms are particularly useful in this capacity. Dense, pinhole free, amorphous structures (without crystallization) may be used. It is noted that metal films may readily crystallize and a dielectric layer may form in a column structure; but with thin, and low temperature deposition (such as magnetron sputtering on cooled substrates), crystallization and column structures can be avoided. Such an oxygen barrier layer may be disposed between the rear substrate and the OLED device layer; for example between the hydrophobic layer 205 and the multilayer structure 201.

Illustratively, the absorbing layers 202 are dark metal layers as referenced in connection with layer 105 of the example embodiment of FIG. 1. These layers foster the dark background desired and allow for an improved contrast at the view surface. Moreover, these layers reduce the stress on the substrates. As described previously, light from the environment (sun light, lamps, etc) is competing with light emitted from the EL layer of an OLED. This ‘environmental’ light, which goes through the OLED structure, must be prevented from being reflected back to the observer's eye. The multilayer structure 201 performs this function, enabling the OLED structure to have excellent viewing contrast.

Absorbing layers 202 are usefully chosen to absorb visible light. Suitable materials for the absorbing layers 204 include, but are not limited, to: thin metal coatings such as Mo, Zr, Ti, Y, Ta, Ni, and W; thin absorbing dielectric materials such as diamond-like carbon, SiOₓ, oxygen-deficient In₂O₃, ITO, SnO₂, and similar materials; or semiconductor materials such as Si, Se, Ge, GaAs, GaN, Se, GaSe, GaTe, CdTe, TiC, TiN, ZnS, ZnO, CdSe, InP and BN. Finally, it is noted that these layers are deposited by standard deposition techniques to a thickness in the range of 1.0 μm to approximately 100 μm, depending on the chosen material(s).

The transparent layers 203 are usefully dielectric layers with thicknesses of approximately 20 nm to approximately 300 nm. Suitable materials include, but are not limited to Al₂O₃, AlON, BaF₂, BaTiO₃, BeO, MgO, GdO₃, Nb₂O5, ThO₂, CeO₂, HfO₂, Se₂O3, SiO₂, Si₃N4, TiO₂, Y₃Al₁₅O₁₂, ZeSiO4, Ta₂O₅, HfN, ZrN, SiC, Bi₁₂SiO₂₀. Depending on the material and wavelength these layers have a thickness in the range of 100 μm to approximately 300 μm.

Finally, it is noted that by controlling the deposition process of the materials of the multilayer stack 201, the example embodiments afford a reduced substrate curving due to the stress of the film stack. To wit, by controlling the process, such as through sputtering pressure control, deposition rate and choice of material, the stress induced can be substantially nullity. For example, as described previously, the metal of multilayer structure (i.e., the light absorbing layers 202) can be chosen to have a stress that negates the stress of the dielectric layers 203. In another example embodiment, this warping of the polymer substrate may be prevented by coating each side of the polymer with a suitable inorganic material (e.g., glass) in order to nullify the stress.

An alternative structure to the coating structure 200 of FIG. 2a is shown in FIG. 2b. The multilayer stack 208 comprises a dielectric layer having a thickness equal to a one-quarter wavelength at a chosen wavelength that is desirably absorbed/not reflected back toward the viewing surface. The stack also includes a reflective surface 210, which reflects the ambient light and a dark metal such as layer 203 above. In addition to absorbing light, the stack 208 functions as an oxygen and humidity barrier. To this end, the materials chosen for the multilayer stack for optical extinction also provide a barrier layer to prevent water vapor and oxygen from reaching the OLED structure.

In the example embodiment the stack 208 forms the ‘dark’ background of the OLED structure in a display. The multilayer stack 208 includes an optical interference structure that cancels light from direction 207 with the light reflected in the direction 212 from different interfaces of the multilayer structure. This reflected light has equal intensity and opposite phase by virtue of the structure if the stack 208. Such optical interference structures are well known in the physical optical arts and are often referred to as dielectric stack filters. For example, the multilayer stack 208 may be of the type described in U.S. Pat. No. 5,521,759, to Dobrowolski, et al., the disclosure of which is specifically incorporated herein by reference.

The dark metal layer 211 is disposed at the far side of the multilayer stack as shown. The layer 210 has a thickness in the range of approximately 50 μm to approximately 200 μm, and also usefully suppresses reflections of ambient light back toward the viewing surface of the OLED structure. It is noted that if the embodiment of FIG. 2b is used, the dielectric layer 209 is usefully one-quarter wavelength thick at approximately 560 nm (most sensitive wavelength region for human vision). This layer also provides a moisture barrier as well. Layer 210 is a metal that is usefully very light-absorbing, such as tungsten or inconel. Alternatively, oxygen deficient InSnOx, or ITO may be used as the light absorbing layer 210. It is noted that stoichiometric ITO is a transparent semiconductor, although its transparency decreases greatly and conductivity increases significantly if oxygen vacancies are increased in the material.

The layers described in connection with FIGS. 2a and 2b may be formed at temperatures below 100 ° C. by known electron-beam, sputtering or web coating techniques, or a combination thereof.

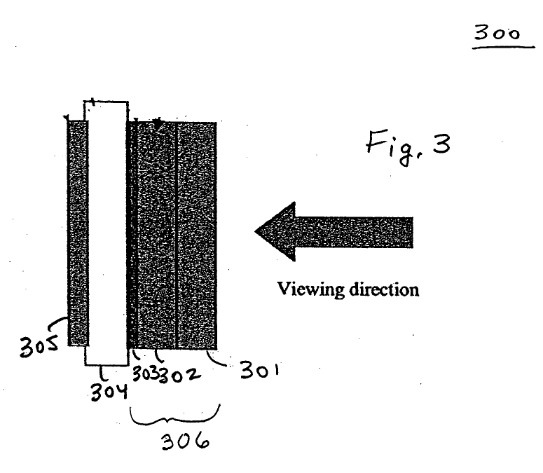

FIG. 3 shows a coating structure 300 that is usefully disposed on the front, or viewing surface of an OLED structure (e.g., viewing surface 106 of the OLED structure 100) in accordance with an example embodiment. For example, the coating structure may be used for the AR layer 107 of the example embodiment of FIG. 1. For example coating structure 300 may be used as the AR coating 107.

The coating structure 300 is a transparent structure that includes multilayer structure 306 comprised of a barrier layer 301 disposed over a transparent layer 302, which is disposed over another transparent layer 303. The transparent layers 302, 303 are of the same materials and thicknesses as the transparent layers of FIG. 2. Transparent layer 303 is disposed over or directly onto a substrate 304. The coating structure 300 has alternating relatively high index of refraction and relatively low index of refraction layers. This structure is commonly known as a ‘low-high-low’ or an LHL stack, and is exceedingly useful in preventing reflections. It is noted that in keeping with the LHL stack structure, the coating structure may have more layers than the three layers specifically shown in FIG. 3.

The substrate 304 is usefully a polymer layer of a material such as described above. The coating structure 300 disposed on the viewing side (e.g., 106) of an OLED structure beneficially reduces reflections from the viewing surface and prevents moisture from penetrating the substrate 304 and reaching the OLED region (e.g., layer 102 of FIG. 1). However, all layers of coating structure are necessarily transparent. Good barrier layers are often materials having a high index of refraction. For example, excellent barrier layers such as Al₂O₃ (n=1.65), TiO₂ (n=2.2-2.3), Ta₂O₅ (n=2.1 to 2.2) have a relatively high indices of refraction may be used according to an example embodiment. As such, it is noted that barrier layer 301 may be a polymer material chosen for its hydrophobic characteristics may be on top of dielectric layer.

With n_{L}/n_{H}/n_{L} antireflection structure of an example embodiment, surface reflection can be cut to less than approximately 2% or even approximately 0.5%. ITO is a high index material, but by changing reactive sputtering gas or evaporation gas during the deposition, index matching of a polymer/plastic substrate with an OLED structure can be achieved to allow improved reflection from at the viewing surface.

It is noted that the additional transparent layers 303 may be disposed over the substrate 304. To this end, the transparent layers 303, and the barrier layer 301 comprise a three-layer antireflection layer, provided the index of refraction of the barrier layer is less than 1.45. Moreover, the transparent layers 302, 303 having different indices of refraction are generally required for an inorganic material multilayer antireflective coating.

In accordance with an example embodiment, a multilayer antireflective coating (e.g., multilayer AR coating 306) is used to enable a broad AR band and provide a relatively improved barrier to contaminants. The choice of each layer depends on the refractive index required, and the thickness required. For a three layer coating, a known condition for the electric vectors to be of equal magnitude and opposite sign is:

y₁/y₀=y₂/y₁=y₃/y₂=y_{sub}/y₃ (eqn. 1)

where yᵢ (i=0,1,2,3 . . . ) is the optical admittance of the i^{th} layer, y_{sub} is the optical admittance of the substrate and yₒ is the optical admittance of the surrounding medium. As such, if n_{substrate}=1.52, a four-layer AR layer of an illustrative embodiment is: MgF (n=1.27 and a thickness of 92.7 nm)/ZrO₂ (n=2.06 and a thickness of 131.7 nm)/MgF (thickness of 30.3 nm)/ZrO₂ (thickness of 16.5 nm).

Finally, an index matching layer 305 of a material such as described in connection with the embodiment of FIG. 2 is disposed over the substrate 304 as shown. This layer, like layers 301, 302 and 303 are fabricated by known methods such as those described in connection with the embodiments of FIG. 2.

One of the layers of the antireflection layer comprised of the barrier layer 301, and the transparent layers 302,303 beneficially is equal to the square-root of the index of refraction of the substrate 301. For example, ITO has a refractive index of approximately 2.0 at 550 nm. The index matching layer 305 should have an index of refraction of approximately 1.81, making for example, Si₃N₄, SION, and BiO₂ likely candidates as the index matching layer 305. To wit, it is useful to provide an index matching layer, because any sudden change in index of two adjacent layers will cause reflection. Reflection will cause glare of the display, which is deleterious for reasons described above.

Finally, it is noted that nanocomposite clays can also be used as the barrier layer 301 in this embodiment to prevent contaminants from reaching the OLEDs and to prevent scratching.

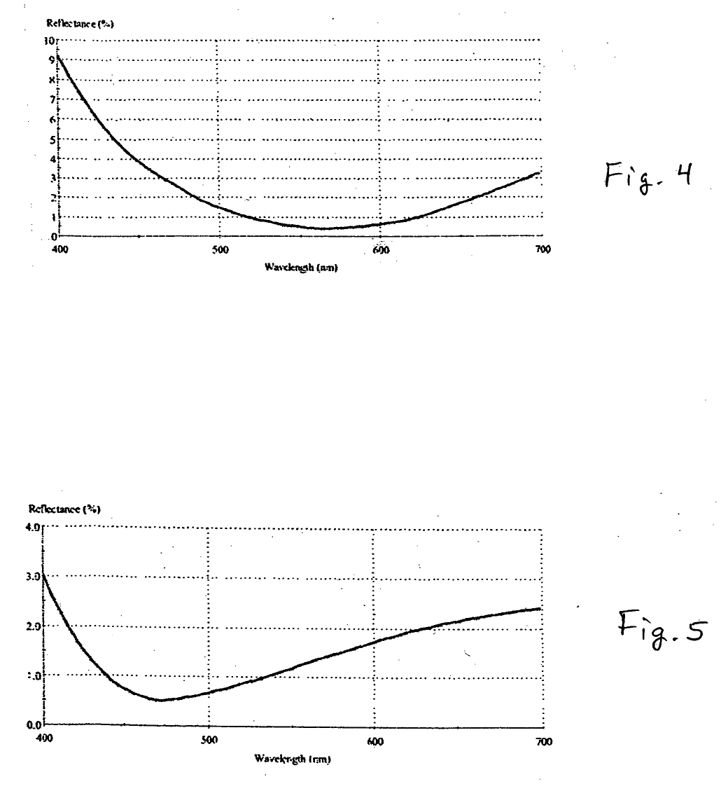

FIG. 4 shows the Reflectance (%) versus wavelength (nm) for a three-layer AR coating on a polymer substrate. The three layers are glass/W (7 nm)/Al (80 nm). As can be appreciated the reflectance is beneficially insignificant over a useful wavelength range.

FIG. 5 shows the Reflectance versus wavelength for a six layer AR coating of Glass/W (6.1 nm)/SiO₂ (78.5 nm)/W (15.3 nm)/SiO₂ (78.5 nm)/Al (71 nm). As can be appreciated, the greater the number of layers in the stack the better moisture barrier property. However, the reduction of reflections from the back side is mostly curbed by the first two or three absorbing metal layers.

The example embodiments having been described in detail in connection through a discussion of exemplary embodiments, it is clear that modifications of the invention will be apparent to one having ordinary skill in the art having had the benefit of the present disclosure. Such modifications and variations are included in the scope of the appended claims.

1. An OLED structure, comprising:
at least one substantially flexible substrate;
at least one barrier layer disposed between the substrate and the OLED structure;
and at least one antireflection (AR) layer disposed between the OLED structure and a display surface.

2. An OLED structure as recited in claim 1, wherein another substantially flexible substrate is disposed over the at least one barrier layer.

3. An OLED structure as recited in claim 1, wherein the at least one AR layer includes a barrier structure.

4. An OLED structure as recited in claim 1, wherein the at least one barrier layer includes at least one stack comprised of a dielectric layer and a light absorbing layer.

5. An OLED structure as recited in claim 4, wherein the at least one barrier layer includes up to ten of the stacks.

6. An OLED structure as recited in claim 1, wherein respective dielectric layers are disposed between the at least one AR layer and the OLED structure, and between the at least one barrier layer and the OLED structure.

7. An OLED structure as recited in claim 2, further comprising a hydrophobic layer between the other substrate and the at least one barrier layer.

8. An OLED structure as recited in claim 2, further comprising a hydrophobic layer between substrate and the OLED structure.

9. An OLED structure as recited in claim 4, wherein the light absorbing layer is a metal.

10. An OLED structure as recited in claim 1, wherein the at least one barrier layer includes: a dielectric layer having a thickness equal to one quarter wavelength of a visible wavelength; a light reflecting layer; and a light absorbing layer.

11. An OLED structure as recited in claim 10, wherein the light absorbing layer is a metal, and the light reflecting layer is a mirror.

12. An OLED structure as recited in claim 5, wherein the dielectric layers each have a mechanical stress, and the light absorbing layers have a mechanical stress, and the mechanical stress of the dielectric layers and the light absorbing layer substantially cancel.

13. An OLED structure as recited in claim 1, wherein the barrier structure and the at least one barrier layer water vapor each prevent permeation water vapor therethrough at a rate less than approximately 10⁻⁶ g/m²/day and oxygen therethrough at a rate less than approximately 10⁻⁵ cm³/m²/day.

14. A light emitting display device, comprising:
at least one substantially flexible substrate;
at least one barrier layer disposed between the substrate and a light emitting structure structure;
and at least one antireflection (AR) layer disposed between the light emitting structure and a display surface.

15. A light emitting display device as recited in claim 14, wherein the AR layer includes a barrier structure.

16. An light emitting display device as recited in claim 14, wherein another substantially flexible substrate is disposed over the at least one barrier layer.

17. A light emitting display device as recited in claim 14, wherein the at least one barrier layer includes at least one stack comprised of a dielectric layer and a light absorbing layer.

18. A light emitting display device as recited in claim 17, wherein the at least one barrier layer includes up to ten of the stacks.

19. A light emitting display device as recited in claim 17, wherein respective dielectric layers are disposed between the at least one AR layer and the light emitting structure, and between. the at least one barrier layer and the light emitting structure.

20. A light emitting display device as recited in claim 15, further comprising a hydrophobic layer between the other substrate and the at least one barrier layer.

21. A light emitting display device as recited in claim 15, further comprising a hydrophobic layer between substrate and the light emitting structure.

22. A light emitting display device as recited in claim 17, wherein the light absorbing layer is a metal.
